(19) United States
(12) Patent Application Publication
(10) Pub. No.: US 2015/0203040 A1
(43) Pub. Date: Jul. 23, 2015

(54) PROXIMITY VIEW MIRROR ASSEMBLY

(71) Applicant: Advanced View Safety Systems Pty Ltd, Moorabbin, Victoria (AU)

(72) Inventor: Craig Hart MacDougall, Moorabbin (AU)

(73) Assignee: Advanced Veiw Safety Systems Pty Ltd, Moorabbin, Victoria (AU)

(21) Appl. No.: 14/400,515

(22) PCT Filed: May 10, 2013
(86) PCT No.: PCT/AU2013/000479

§ 371 Date: Nov. 11, 2014

(30) Foreign Application Priority Data
May 11, 2012 (AU) 2012901942

(51) Int. Cl. B60R 1/10; G02B 7/182

(52) U.S. Cl. CPC B60R 1/10; G02B 7/1822

(57) ABSTRACT

A proximity view mirror assembly (1) for a mobile vehicle (2) comprising a first mirror (3) adjustably mounted to said vehicle and adapted for direct viewing by a seated driver of said vehicle, a second mirror (5) adjustably mounted relative to said first mirror wherein said first and second mirrors are generally opposed, of a similar size and vertically offset so as to co-operated and provide the seated driver with a generally forward proximity view of said vehicle.

### BACKGROUND OF THE INVENTION

This invention relates to vision accessory devices for use on mobile vehicles and in particular to a vision aid to improve the field of vision in forward proximity to the immediate surroundings of the vehicle in question.

Vision improving devices and accessories for use with roadworthy vehicles include a wide range of devices ranging from simple to complex mirror systems through to cameras and other more technically involved aids with a view to improving or assisting a driver's vision which is generally confined to the immediate field of vision of a driver securely strapped and located to the vehicle in question.

Of the many types of vision accessories, forward view accessories form a prominent part of the prior art with such accessories being specifically designed for the purpose of improving the available range of forward vision for the driver of a road vehicle. Most particularly, the usual circumstances have the driver of such a vehicle positioned either to the left or the right hand side of the vehicle which severely restricts the forward view from the far side of the vehicle opposite the side on which they are seated and driving the vehicle.

Such forward view mirror systems and arrangements are predominantly designed and configured to provide long range forward vision for a moving vehicle or long range forward vision to assist in parking and manoeuvring a slow moving vehicle.

Whilst such forward view accessories provide assistance, particularly for long range forward viewing, none of the available forward view systems provide for a high degree of improved vision within close proximity to the whole front end of a vehicle. Accordingly, all of the known forward vision accessories and systems exhibit severe limitations when they are adapted or applied to be used in respect of highly utilitarian vehicles of the nature of forklift trucks, front-end loaders, tractors, graders and mowers etc. Such vehicles are not road bound and generally find use in highly confined areas, often involving the manipulation of large loads. Such vehicles, and in particular the type of use they are put to in manipulating large forward positioned loads, have a very specific forward view requirements where the driver can be moving slowly but moving with a bulky forwardly positioned manipulating tool. In the case of the forklift, where the forklift tines project forward from the vehicle or in the case of a front-end loader, where the bucket or scoop is positioned forward of the tractor or loading vehicle. In these circumstances, the operator or driver of such a highly utilitarian vehicle will experience greatly restricted proximity vision within the immediate environment of the forwardly positioned accessory to the vehicle. In such circumstances, drivers of such vehicles often have to resort to leaving their seated position, including unbuckling safety harnesses and the like, in order to achieve the necessary visual confirmation that the forwardly positioned tool being manipulated by the vehicle, in the form of fork lift tines or front-end loader buckets is not causing damage or inappropriate manipulation unbeknownst to the driver.

### SUMMARY OF THE INVENTION

Accordingly, one object of the invention is to provide an improved proximity view mirror assembly particularly adapted for use on a range of highly utilitarian vehicles so as to provide the operator of such vehicles with improved visual access to the immediate proximity of the vehicle and an associated tooling manipulated from the vehicle.

In a first aspect the invention provides a proximity view mirror assembly for a mobile vehicle comprising a first mirror adjustably mounted to said vehicle and adaptable for direct viewing by a seated driver of said vehicle, a second mirror adjustably mounted relative to and depending directly from said first mirror independent of said vehicle wherein said first and second mirrors are generally opposed, of a similar size and vertically offset so as to co-operate and provide the seated driver with a generally forward proximity view of said vehicle and wherein said assembly is of a generally open construction to allow ready adjustment.

The adjustment of the first mirror relative to the vehicle preferably maintains the relative constant mounting of the first and second mirrors to each other.

The second mirror is preferably configured to provide the driver with a wide angle view within the forward proximity of said vehicle.

The second mirror is most preferably parabolic in configuration.

The parabolic configuration most preferably allows a single parabolic shape to be inverted for left and right hand use.

The open assembly preferably includes a primary mount bracket for attaching said first mirror to said vehicle. The assembly further includes a second mirror mount comprising upper and lower mount arms extending outwardly from said first mirror for mounting said second mirror relative and in general opposition thereto. The second mirror mount is preferably pivotally fitted to said primary mount bracket. The second mirror mount may provide a range of pivot points to accommodate maximum adjustability. The range of pivot points may be incremented or adjustable via a servo motor. The upper and lower mount arms of the second mirror mount preferably include extended pivot points positioned about midway across the width of said first mirror.

In order to provide additional flexibility for pivot adjustment the primary mount bracket may include upper and lower primary mount arms intermediate between said primary mount bracket and said second mirror mount. The upper and lower primary mount arms may be arcuate and provided with a corresponding curved index plate to allow further adjustment of said assembly from said primary mount bracket.

The second mirror may include a second mirror fixing bracket to pivotally co-operate with said second mirror mount arms via an upper and lower clutch.

The second mirror bracket preferably mounts to the inner edge of said second mirror so as to provide a horizontal offset between the first and second mirrors.

The said first and second mirrors are preferably fitted to respective first and second backing plates of similar size such that said upper and lower clutch provide said vertical offset.

The first mirror may be pivotally mounted to said primary mount bracket via an upper and lower clutch.

The clutch may include a radially positioned roller pin with a biased roller ball. The roller ball may co-operate with an under plate positioned therein between to provide incremental pivotal adjustment of said second mirror relative to said first mirror.

In an alternative embodiment the clutch includes a two part clutch housing adapted to receive the pivoting components, a lower index spacer fitted to a first part of said housing, an upper index spacer positioned between said first and second housing parts, a clutch plate positioned intermediate between said upper and lower index spacer and a tension spring adapted to bring said upper and lower index spacers into contact with said clutch plate so as to provide a degree of resistance to rotation about said pivots.

### DETAILED DESCRIPTION OF THE DRAWINGS

The invention will now be described with reference to one particularly preferred embodiment as detailed in the accompanying Figures and Legend.

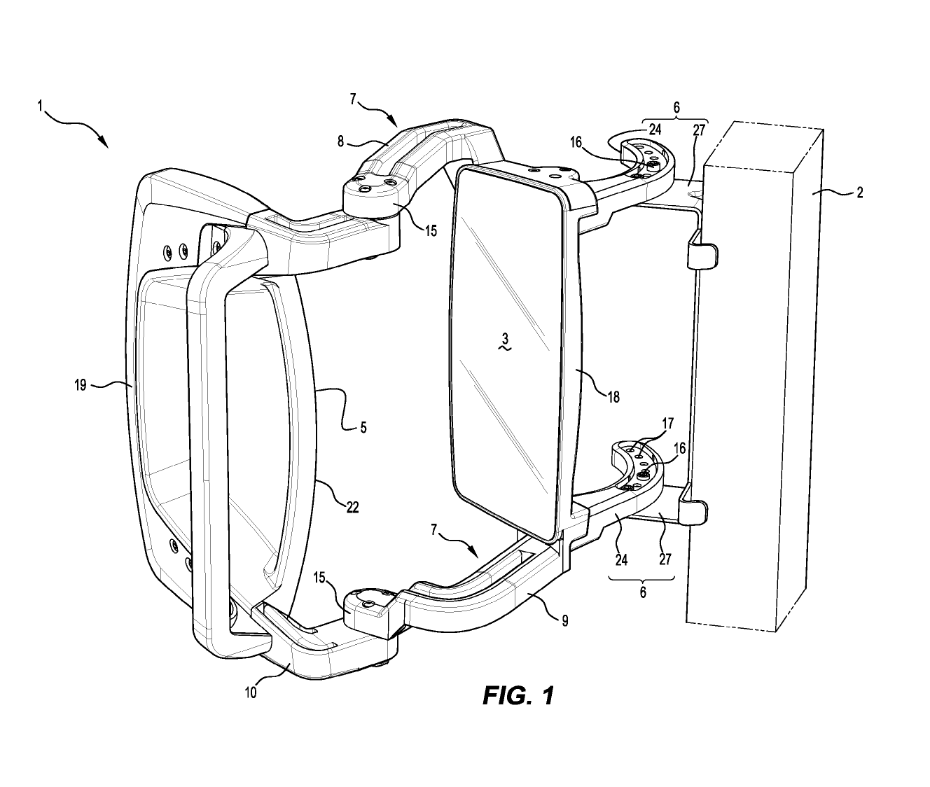

FIG. 1 shows a perspective view of the mirror assembly as fitted to the left hand side of a vehicle.

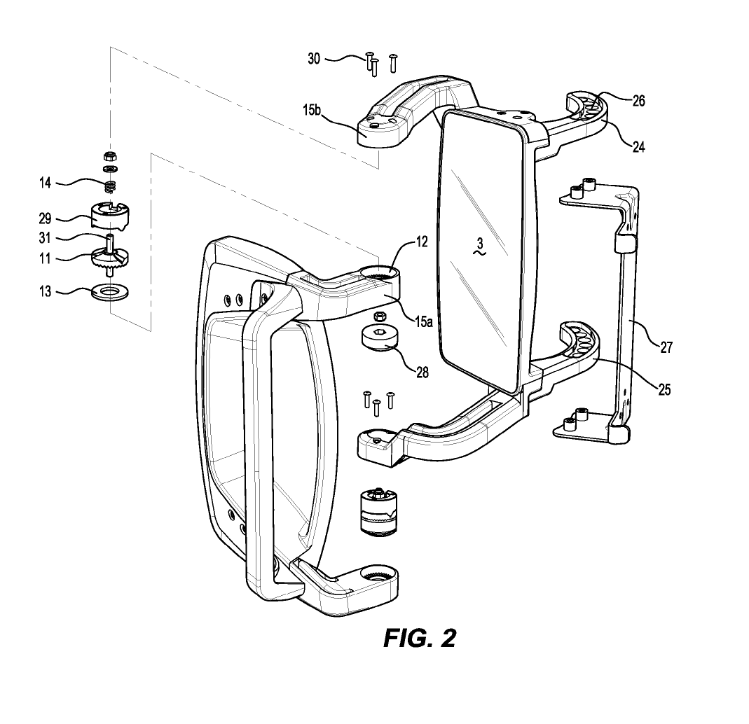

FIG. 2 shows an axonometric exploded view of the assembly with detail of the second mirror fitting and clutch system.

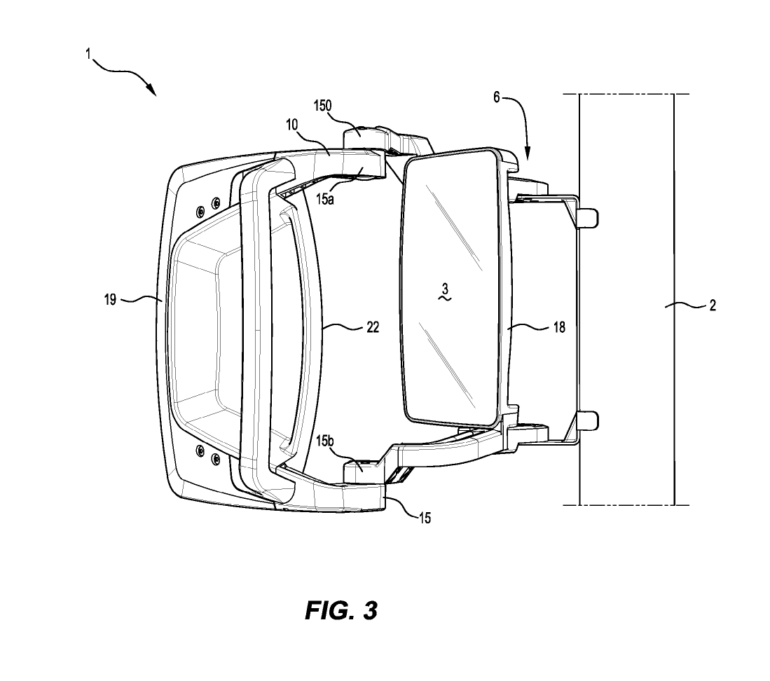

FIG. 3 shows a front view of the assembly from the driver's perspective.

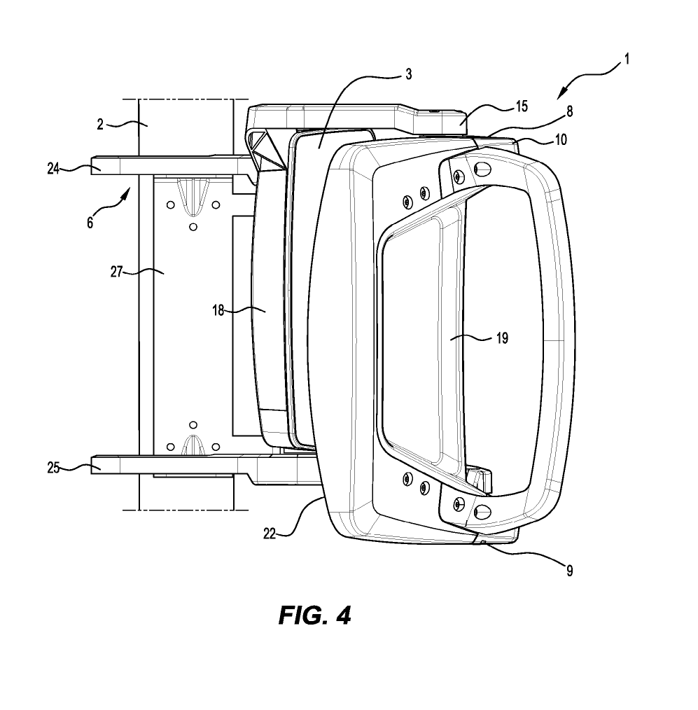

FIG. 4 shows a side view of the assembly from outside the vehicle.

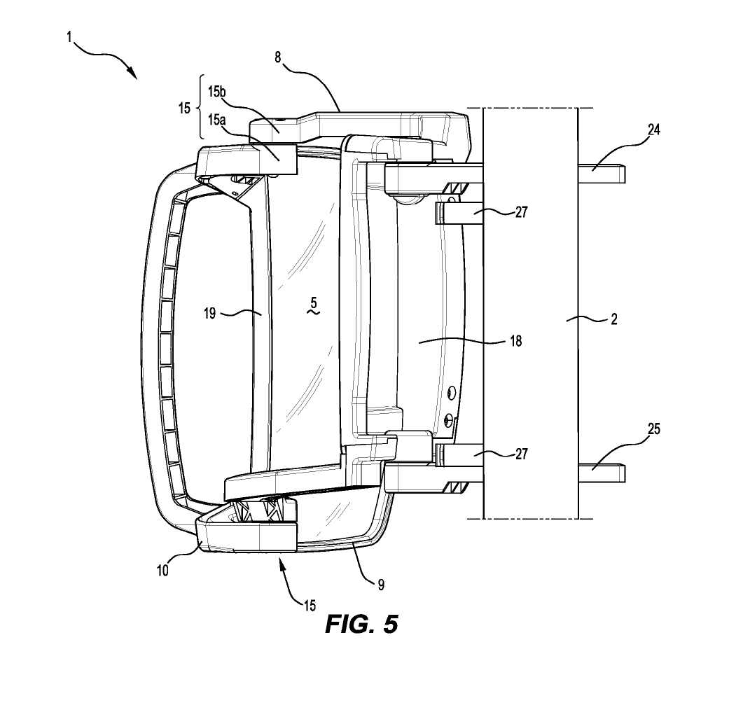

FIG. 5 shows a side view from inside the vehicle.

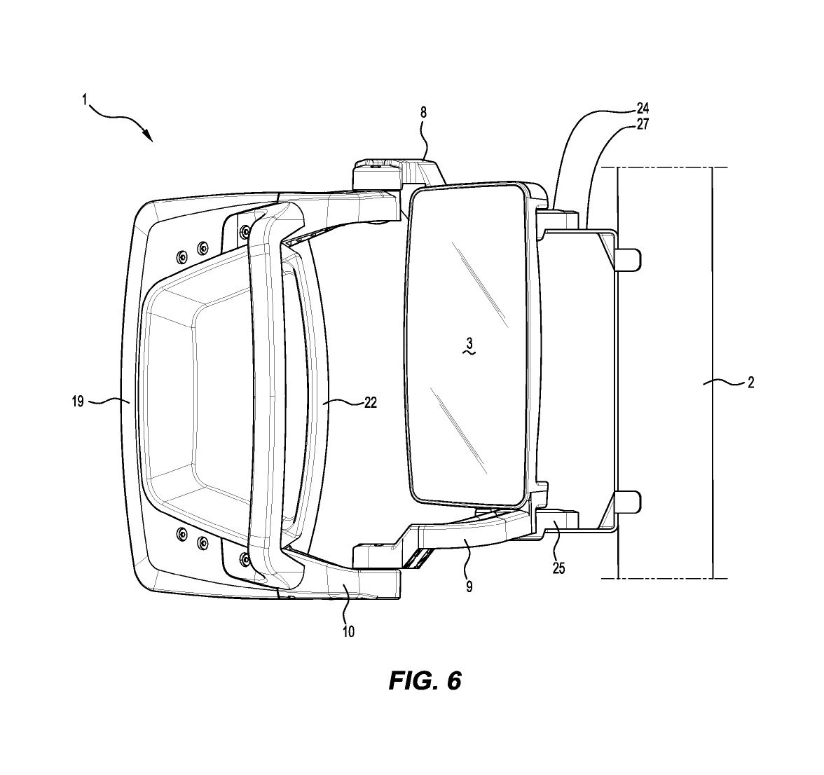

FIG. 6 shows a rear view of the assembly as seen from the front of the vehicle.

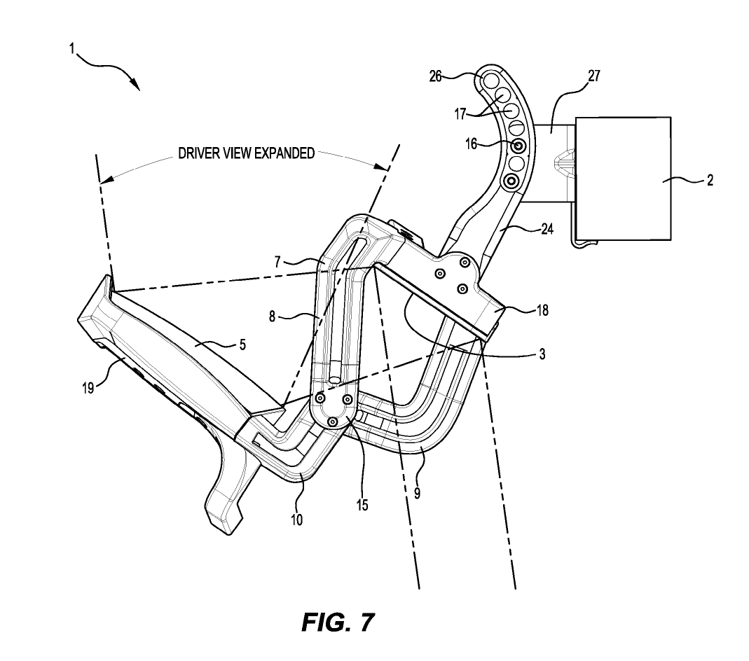

FIG. 7 shows a plan view of the assembly.

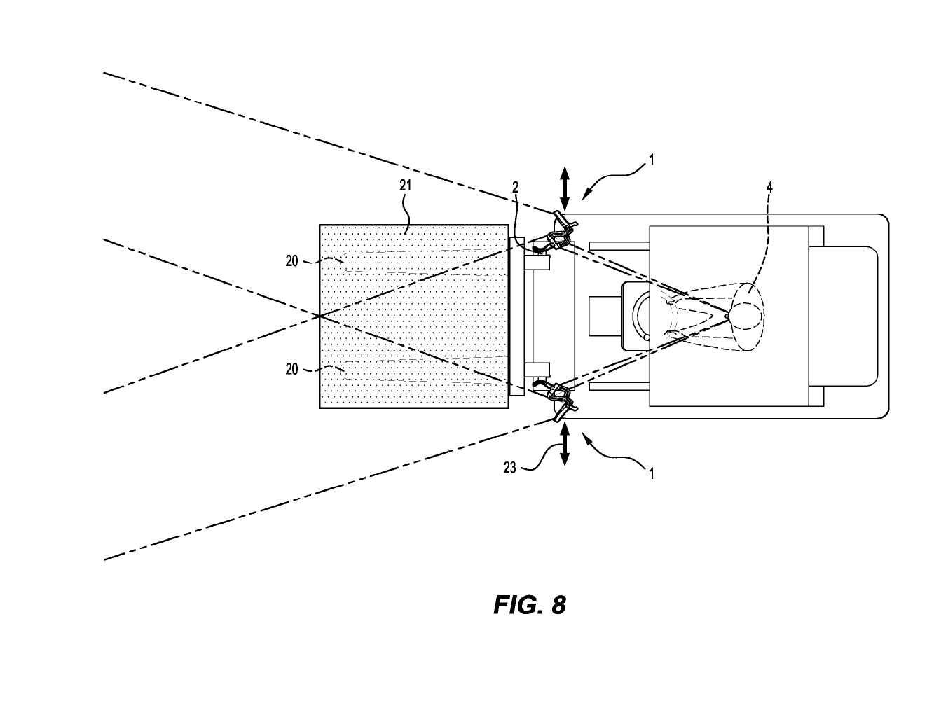

FIG. 8 shows a top view of the proximity view sight lines provided by the assembly as fitted to both left and right hand sides of a vehicle.

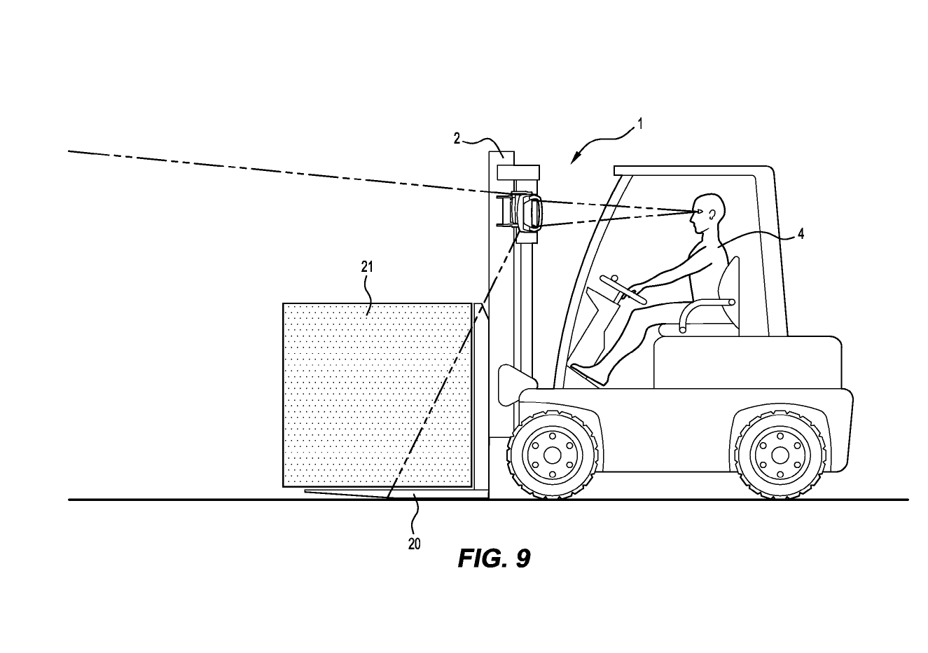

FIG. 9 shows a side view of the proximity view sight lines provided in the assembly.

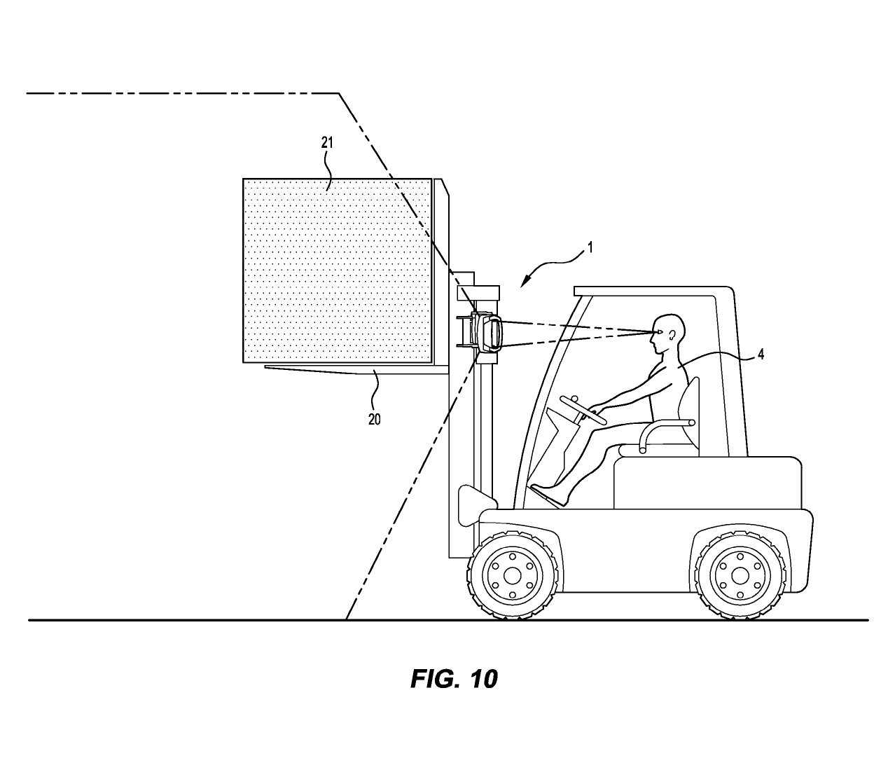

FIG. 10 shows the proximity view sight lines during vertical extension of a load.

### LEGEND

1. Mirror assembly
2. Mobile vehicle
3. First mirror
4. Seated driver
5. Second mirror
6. Primary mount bracket
7. Second mirror mount
8. Second mirror upper mount arm
9. Second mirror lower mount arm
10. Second mirror fixing bracket
11. Upper index spacer
12. Lower index spacer
13. Clutch plate
14. Tension spring
15. Clutch housing
15a. Clutch housing first part
15b. Clutch housing second part
16. Primary mount pivot
17. Primary mount pivot points
18. First mirror backing plate
19. Second mirror backing plate
20. Tines
21. Load
22. Inner edge
23. Lateral extension
24. Upper primary mount arm
25. Lower primary mount arm
26. Curved index plate
27. Primary mount bracket backing plate
28. Adjusting screw
29. Fitting Collar
30. Fastening means
31. Axle

### DETAILED DESCRIPTION

Referring firstly to FIGS. 1 and 2, the proximity view mirror assembly 1 of the invention will now be described in detail with reference to one particularly preferred embodiment with the proximity view mirror assembly being fitted to a forklift. The mirror assembly of the invention is readily adapted for fitting to a range of high utility vehicles where a high level of adjustability allows one assembly to be readily fitted to a range of vehicles. The particular adaptation exemplified herein on a forklift represents one embodiment only.

FIGS. 1 and 2 show a perspective and in part exploded view of the proximity view mirror assembly 1 of the invention as applied to a forklift as representative of one of a range of mobile vehicles 2. The mirror assembly comprises a generally open construction not confined to a restrictive housing so as to enable the mirror assembly to be readily adjusted by the user whilst also allowing the various components of the assembly to be pivotally rotated and swung out of the way when used in highly confined areas or subjected to accidental impacts.

The proximity view mirror assembly comprises two key components being a first substantially flat mirror 3 which is positioned for direct viewing by the seated driver 4 shown in FIGS. 8 to 10. The first mirror is represented by a substantially flat mirror and co-operates with a second mirror 5 which is mounted so as to oppose the first mirror 3 and thereby provide a line of vision for the driver from the first mirror to the second mirror to provide the proximity view toward the front of the vehicle.

The proximity view required or desired in the case of highly utilitarian vehicles is that of close range and close proximity forward viewing of the immediate environment forward of the vehicle. In the case of the exemplified embodiment shown in FIGS. 8 and 9, the forward projecting tines 20 of the forklift are specifically adapted for the dedicated lifting and manipulation of a load 21. Once the load is engaged by the tines 20, any forward vision within the immediate proximity of the load or the supporting tines is greatly restricted during manipulation and use of the fork lift vehicle.

The substantial inhibition of the forward proximity view around the load 21 provides many impediments and potential dangers in use of a forklift vehicle and similar analogous problems and situations arise with the use of alternative utilitarian vehicles of the likes of a front-end loader where the tines 20 would be replaced by a loading bucket and thereby presenting similar problems to those just described.

Referring now to all the Figures, the generally open construction of the assembly 1 of the invention is provided by the generally exposed bracketing and mounting system which encourages ready adjustment of the first 3 and second mirrors 5 thereby allowing the assembly of the invention to be applied in left or right hand configurations and readily adjustable as required for application to a wide range of different utility vehicles.

The primary mounting bracket 6 provides the initial mounting point and can be fitted to a convenient point on the mobile vehicle 2 which in the form of a fork lift finds the bracket most conveniently mounted to the right or left hand fork lift mast. The primary mount bracket 6 can be either bolted to the fork lift mast or alternatively fitted by way of dedicated lugs provided on the mast. Alternatively, the primary mount may be fitted with provision for adjustment relative to said mast. Such adjustment may include manually variable mount points or servo assisted mounting. The primary mount 6 has two outwardly projecting arms terminating in a mount pivot 16 for attachment of the first mirror 3. The outwardly projecting arms may be formed as a permanent part of the bracket or preferably formed as an upper 24 and lower 25 primary mount arm adapted for adjustable fitting to the primary mount bracket backing plate 27. Each of the upper and lower mount arms are formed as an arc and include respective index plates curved to correspond with the arcuate curve of the arms. The provision of the index plate allows the primary mount arms of the primary mount bracket to be adjusted so as to position the remainder of the assembly relative to the vehicle.

The first mirror 3 is provided with a backing plate 18 so as to provide the first mirror with rearward protection and also a convenient location for mounting via the primary mount bracket 6. In addition, the first mirror backing plate 18 provides a convenient point for mounting the upper and lower second mirror mount arms 8 and 9 and in one embodiment the upper and lower second mirror mount arms 8 and 9 include integral mount pivot points 16 with a range of linear pivot points 17 providing not only a ready means of pivoting the first mirror but also a means of lateral adjustment of the preferred pivot point relative to the primary mount bracket 6. Alternatively, a sliding mount operated via a servo motor may provide for adjustment of the pivot point. However, in a particularly preferred embodiment a clutch assembly is provided for fitting the first mirror to the upper and lower primary mount arms, with a similar clutch assembly used for fitting the second mirror to the second mirror upper and lower mount arms. The clutch assembly is detailed in FIG. 2A where a two part clutch housing 15 is fitted to the end of the respective components to be joined. Each housing includes a lower index spacer (12) having tangential teeth which co-operate with an upper index spacer (11) via an intermediate clutch plate 13. The clutch plate is made of a compliant material to provide a stepless, but resistive relative rotation for the two part clutch housing 15 and associated component. The clutch housing includes a first housing part 15A and a second housing part 15B. A fitting collar 29 is provided to sit in the second part of the clutch housing 15b and is attached thereto by suitable fastening means 30. The upper index spacer 11 is provided with a central threaded axle 31 which co-operates with the collar 29 and passes through the clutch housing first part 15a such that the threaded end can be engaged by adjusting screw 28. In this manner each clutch can be set by winding of the adjustment screw to allow free rotation of the first and second housing parts to make suitable adjustment for the mirrors. Once the mirrors are set, the adjusting screw is tightened to draw the first and second housing parts together and hence draw the upper and lower index spacers into contact with the clutch plate to set the resistance to rotation and hence set the adjustment for the mirrors. In this way each clutch allows the mirrors to have a pre-set position. If the mirrors are knocked or bumped they can be readily clicked back into the pre-set position. The degree of resistance can be altered by changing the tension of the intermediate spring 14 such that once the clutch assembly is fitted and assembled the relative rotation of the associated components moves with a predetermined degree of resistance. In the embodiment of the invention the inner (first mirror) and outer (second mirror) clutches are varied to allow the second mirror to be readily adjusted to suit the individual driver without altering the setting of the first mirror. Whilst all four clutches can be set independently the preferred setting has the two outside clutches, which pivot the second mirror relative to the first mirror, set with a spring having a lesser tension that the two inner clutches which pivot the first mirror (and the whole assembly) to the vehicle. In this manner, the second mirror can be readily adjusted without interfering with the first mirror setting allowing individual drivers to adjust the assembly to suit their driving position without having to set both mirrors. An additional benefit of a lesser tension for the second mirror allows the second mirror to be knocked, as will happen in normal use of a forklift from time to time, and fold away without altering the setting of the first mirror. Again, this minimises resetting of the assembly back to functional use. Of course, if the assembly if subject to a greater knock the higher tension of the clutch spring for the inner mirror allows the whole assembly to fold back away from harm or damage. The mounting of the first mirror 3 to the primary mount bracket 6 and the upper and lower second mirror mount arms 8 and 9 which are fitted to the top and bottom of the first mirror backing plate 18 allow the first mirror to be freely pivoted such that any pivotal movement of the first mirror 3 results in sympathetic movement of the upper and lower second mirror mount arms 8 and 9 which follow the movement of the first mirror and accordingly ensure that the second mirror 5 attached to the remote ends of the upper and lower mount arms 18 also moves relative to the first mirror such that the relationship as effected between the first and second mirrors remains constant unless specifically changed.

The outwardly projecting upper and lower second mirror mount arms 8 and 9 are configured to position the second mirror pivot point along with the upper and lower clutch housings 15 midway across the width of the first mirror which is best seen from the plan view as shown in FIG. 7.

The first and second mirrors are preferably of similar sizes and the vertical offset relationship between the first and second mirrors is most readily established by the positioning of the clutch assembly and housing 15 on the underside of their respective second mirror upper and lower mount arms so as to displace the second mirror when mounted via the second mirror fixing bracket 10. The second mirror fixing bracket 10 is fitted to the inner edge 22 of the second mirror backing plate 19 so as to displace the horizontal orientation of the second mirror from the first mirror such that the combined use of the clutch housing as spacers and the edge mounted bracket of the second mirror causes the first and second mirrors to be displaced both vertically and horizontally relative to each other.

In order to facilitate the ready adjustment of the mirror assembly, the invention provides for differing degrees of adjustment of the second mirror 5 relative to the first mirror 3 when contrasted with adjustment of the first mirror 3 alone which causes the sympathetic movement of the second mirror 5 such that movement of the first mirror alone does not alter or effect the relative adjustment and relationship between the first mirror 3 and the second mirror 5. In order to provide an intuitive and robust adjustment of the relationship between the first mirror 3 and the second mirror 5, the pivotal adjustment via the second mirror upper and lower mount arms 8 and 9 may be provided by way of indexing of the upper spacer 11 and lower spacer 12. In a particularly preferred embodiment the spacers are separated by a compliant clutch plate (13) which co-operates with a tensioners spring (14) to apply a resistance to the pivoting movement. The compliant clutch plate introduces infinite rotational adjustment by interfacing the separate teeth of the spacers. The teeth are preferably configured tangentially.

Referring specifically to FIG. 8, the location of the mounting point to the mirror system may be included within the footprint of the vehicle. However, the mounting of the mirror system can extend laterally 23 to increase the field of view and if required the operator of the mirror can move the primary mount point 6 beyond the footprint of the vehicle, either by way of an additional bracket or alternatively with the use of an incorporated extendible arm so as to allow the mirror system of the invention to be moved beyond the immediate footprint of the vehicle so as to improve or increase the field of view as required in accordance with particular circumstances.

In normal usage, the relationship between the first and second mirrors will be set for any given vehicle, for example, a fork lift would have a given position and in all likelihood a front-end loader would require a different relative positioning of the first and second mirrors. Once that relationship is established, the combined first and second mirrors generally require adjustment in concert which can be accomplished by the movement of the first mirror which causes sympathetic or corresponding movement of the second mirror 5 which is attached thereto by way of the upper and lower second mirror mount arms being integrally attached to the first mirror backing plate 18.

Once the configuration and alignment of the figures has been established, the proximity view assembly of the invention provides the lines of sight as shown in FIGS. 8, 9 and 10 which provide close proximity views of the forward region of the vehicle 2 for the driver 4. As particularly shown in FIG. 10, the proximity view offered by the invention extends vertically upward raising above the height of the fork of the forklift. Equivalent flexibility of the invention applies when the mirror system is fitted to alternative utility vehicles.

In a particularly preferred embodiment, the assembly of the invention can be manufactured in a highly economical manner with the provision of similar sized mirrors for the first and second mirrors and reversible mount brackets with the primary mount bracket 6 being able to be reversed up and down for positioning either left or right of the vehicle. The second mirror upper and lower mount arms 8 and 9 are of identical configuration and reversible such that a single mount arm can function both in the upper and lower configuration by simple reversal. The vertical displacement of the respective first and second mirrors allows mirrors of similar size and configuration to be used thereby allowing the simple inversion thereof for use in respective right and left hand versions. In addition, the compact nature of the various components allows the assembly to be packaged economically and efficiently for ready assembly and application to a range of utility vehicles.

For ease of fitting, the primary mount backing plate 27 may be provided with top and bottom locating lugs to position the assembly on the back out facing corner of the mast of the forklift. The plate can then be fixed by bolts, magnets, double sided tape or the like.

In a particularly preferred embodiment both first and second mirrors are provided with heating means. The mounting arms of the assembly and backing mirror plates may include dedicated channels for fitting of electrical cable.

In use on forklift vehicles the preferred height from ground to the bottom of the backing plate 27 has been found to be 1.2 metres.

Whilst the invention has been particularly described with reference to a forklift vehicle, the assembly finds use as applied to a wide range of vehicles by incorporation of minor modifications which do not detract from the scope of the invention.

1-19. (canceled)

20. A proximity view mirror assembly for a mobile vehicle comprising a first mirror adjustably mounted to said vehicle and adapted for direct viewing by a seated driver of said vehicle, a second mirror adjustably mounted relative to and depending directly from said first mirror independent of said vehicle wherein said first and second mirrors are generally opposed, of a similar size and vertically offset so as to co-operated and provide the seated driver with a generally forward proximity view of said vehicle such that adjustment of the first mirror relative to the vehicle preferably maintains the relative constant mounting of the first and second mirrors to each other.

21. An assembly according to claim 20, wherein said assembly is of a generally open construction to allow ready adjustment by said driver.

22. An assembly according to claim 20, wherein said second mirror is configured to provide the driver with a wide angle view within the forward proximity of said vehicle.

23. An assembly according to claim 22, wherein said second mirror has a parabolic configuration.

24. An assembly according to claim 23, wherein said parabolic configuration is formulated to allow a single parabolic shape to be used for right and left hand versions of said assembly.

25. An assembly according to claim 21, wherein said open construction includes a primary mount bracket for attaching said first mirror to said vehicle.

26. An assembly according to claim 25, further including a second mirror mount comprising upper and lower mount arms extending outwardly from said first mirror for mounting said second mirror relative to and in general opposition to said first mirror.

27. An assembly according to claim 26, wherein said second mirror mount is pivotally fitted to said primary mount bracket.

28. An assembly according to claim 27, wherein said second mirror mount includes a range of pivot points for said second mirror mount.

29. An assembly according to claim 25, wherein said primary mount bracket includes upper and lower primary mount arms intermediate between said primary mount bracket and said second mirror mount.

30. An assembly according to claim 29, wherein said upper and lower primary mount arms are arcuate and include corresponding curved index plates to allow adjustable fitting of said assembly to said vehicle.

31. An assembly according to claim 26, wherein said second mirror mount provides a range of pivot points from said primary mount bracket to increase flexibility of adjustment.

32. An assembly according to claim 31, wherein said range of pivot points are provided by a linear or circular range of pivot points.

33. An assembly accordingly to claim 26, wherein said second mirror includes a second mirror fixing bracket adapted to pivotally co-operate with said second mirror mount.

34. An assembly accordingly to claim 33 wherein said second mirror fixing bracket mounts to the inner edge of said second mirror so as to provide a horizontal offset between the said first and second mirrors.

35. An assembly accordingly to claim 34 wherein said second mirror fixing bracket is fitted with vertical offset to said second mirror mount to provide said vertical offset between said first and said second mirrors.

36. An assembly according to claim 27, wherein said pivot includes a clutch for controlling the pivoting action.

37. An assembly according to claim 36, wherein said clutch includes a two part clutch housing adapted to receive the pivoting components, a lower index spacer fitted to a first part of said housing, an upper index spacer positioned between said first and second housing parts, a clutch plate positioned intermediate between said upper and lower index spacer and a tension spring adapted to bring said upper and lower index spacers into contact with said clutch plate so as to provide a degree of resistance to rotation about said pivots.
